(19) United States
(12) Patent Application Publication
(10) Pub. No.: US 2005/0073789 A1
(43) Pub. Date: Apr. 7, 2005

(54) Solid state multi-pole switching device for plug-in switching units

(76) Inventor: James Tanis, New York, NY (US)

Correspondence Address: OSTRAGER CHONG FLAHERTY & BROITMAN PC, 250 PARK AVENUE, SUITE 825, NEW YORK, NY, 10177, US

(21) Appl. No.: 10/921,699

(22) Filed: Aug. 19, 2004

Related U.S. Application Data
(60) Provisional application No. 60/498,724, filed on Aug. 28, 2003.

(51) Int. Cl. H02H 3/00

(52) U.S. Cl. 361/100

(57) ABSTRACT

A solid state multi-pole switching device has input terminals for a plurality (n) of input control circuits, output terminals for a plurality (m) of output circuits each having an associated solid-state switch unit for switching a respective external circuit load, and a field-programmable unit coupled between the n input control circuits and the m output circuits for selectively establishing an electrical connection of any input control signal to any selected output circuit. The device components are carried on a main circuit board, with the solid state switch units (Triacs) mounted on plug-in boards selectively installed in an array of sockets on the main circuit board. The field-programmable unit may be a simple pin-and-jumper array, or a CPU coupled to an LCD display and settings control device. Timer controls may be programmed through the CPU for automatic on/off switching without the need to manually activate the input control circuits. The device allows a field installer or user to program the desired input/output switching connections onsite, with output circuits being grouped and controlled by input control signals in any desired combination. The device can be used in a wide range of multi-circuit switching control applications such as commercial, industrial or home lighting applications including, but not limited to, stadium lighting, office space lighting, industrial plant lighting, school lighting, home interior or exterior lighting, or store lighting and display.

This U.S. patent application claims the priority of U.S. Provisional Application No. 60/498,724 filed on Aug. 28, 2003, entitled “Solid State Multi-Pole Switching Device With Circuit Grouping”, of the same inventor.

### TECHNICAL FIELD

This invention generally relates to a solid state switching device, and more particularly, to one which can handle multi-pole switching circuits.

### BACKGROUND OF INVENTION

Switching devices that employ a mechanical contact to switch power on/off to a circuit are subject to mechanical failure, wear, corrosion, current transients, and other problems that can degrade their performance. For example, U.S. Pat. No. 4,430,579 to D. Wiktor describes a previous type of “Electrically Operated, Mechanically Held Electrical Switching Device”. The switching actuator is solenoid operated with an armature movable between two positions and held in each position by a spring-biased element. It would be desirable to provide an improved switching device that has no moving contacts to create unwanted electrical noise or deteriorate over time, and that can perform on/off switching more controllably and with faster times.

Solid state switching devices have been developed which overcome many of the problems of the mechanical switching devices. U.S. Pat. 4,801,828 to Ishikawa et al. describes a typical “Multiphase Solid-State Contactor” which employs a multiphase input signal to electronically switch three thyristor firing circuits for controlling the 3-phase power supply to an electric utility customer. However, this prior type of solid-state switching device is used to switch connected or dedicated circuits, and cannot readily be used to switch multiple circuits grouped together in selected groups and controlled by selectable input control signals. For example, it would be desirable to have a solid-state switching device that an installer or user can configure in the field or a user can configure for onsite operation to enable selected input control signals to control selected ones of a large array of commercial, industrial or home lighting circuits, including but not limited to lighting circuits for stadiums, office spaces, industrial plants, schools, home interior, exterior, and lawn, or store lighting and display circuits for daylight, night-time, and after-hours operation.

### SUMMARY OF INVENTION

In accordance with the present invention, a solid state multi-pole switching device comprises:
(a) a first plurality (n) of input control circuits each configured to provide an individual input control signal for controlling the switching of one or more output circuits;
(b) a second plurality (m) of output circuits each having an associated solid-state switch unit connected to an output terminal (pole) connectable to a respective external circuit load;
(c) a field-programmable unit coupled between the n input control circuits and the m output circuits for selectively establishing an electrical connection connecting any input control signal to one or more solid-state switch units for any selected one or more of the output circuits,
whereby the n input control circuits can be connected by the field-programmable unit to any of the m output circuits in any desired combination of groupings controlled by any selected ones of the input control signals.

In a preferred embodiment, input terminals for the input control circuits, solid-state switch units, and output terminals (poles) for the output circuits are all carried on a main circuit board. The output circuits have their output terminals arranged in an array of a selected maximum number (e.g., m=16), and a corresponding array of sockets for plug-in switch units (Triacs) which can be installed as needed on the main board up to the maximum number. The input control circuits have respective terminal blocks for installing input contact switches up to a selected number (e.g., n=4). The input contact switches may be maintained or momentary contact switches (e.g., a rocker or pushbutton), or may include motion sensors, photo cells, or remote actuated switches. The field-programmable unit may be in a simplified form having n pin jumper positions for each of the m output circuits, and the desired connections are established by field-installing jumpers on the main board between each selected input control circuit and each selected output circuit. Alternatively, the field-programmable unit may take the more advanced form of a CPU for setting the input/output connections using an LCD display and settings control knob to enable a field installer or onsite user to program the desired connections. Timer controls may be programmed through the CPU for automatic on/off switching without the need to manually activate the input control circuits.

The solid state multi-pole switching device of the present invention allows an installer or user to program the desired input/output switching connections in the field or for onsite operation. The output circuits can be grouped and controlled by input control signals in any desired combination. The device can therefore be used in a wide range of multi-circuit switching control applications such as commercial, industrial or home lighting, including but not limited to store lighting and display, stadium lighting, office space lighting, industrial plant lighting or school lighting. It is made modular so that only the necessary input control modules and output switch units need to be installed at any time. The modular components can be individually replaced without replacing the entire unit, or disturbing other circuits. After initial installation, more control modules and/or plug-in switch units can be easily installed and programmed as desired.

Other objects, features, and advantages of the present invention will be explained in the following detailed description of the invention having reference to the appended drawings.

### BRIEF DESCRIPTION OF DRAWINGS

FIG. 1A is a block diagram of input control circuits in a first embodiment of the present invention, and FIG. 1B shows the pin jumper arrays used to program the desired input/output connections to output circuits in the first embodiment.

FIG. 2 is a plan view of a main circuit board layout for the first embodiment showing the pin jumper arrays without the other components installed.

FIG. 3 is a front elevation view of the circuit board in FIG. 2 taken along view lines A-A.

FIG. 4 is a side elevation view of the circuit board in FIG. 2 taken along view lines B-B.

FIG. 5 is a schematic logic diagram depicting an example of the first embodiment in a typical scenario of operation.

FIG. 6 is a block diagram of an overall circuit configuration for a second embodiment showing a CPU and on-board LCD display and setting control used to program the desired input/output connections in the second embodiment.

FIG. 7 is a plan view of a circuit board layout for the second embodiment showing the modular socket arrays without the other components installed.

FIG. 8 shows a typical installation wiring scenario for an example of the second embodiment in operation.

FIGS. 9A-9G illustrates a programming sequence for programming an input control signal to selected ones of the output circuits (poles).

FIG. 10 illustrates a control signal setup menu for the CPU in the second embodiment for programming of the input control signals.

FIG. 11 illustrates a logic diagram for programming the CPU in the second embodiment for programming of the input control signals.

### DETAILED DESCRIPTION OF INVENTION

In the following description, certain representative examples of the solid state multi-pole switching device of the present invention are described with reference to specific types and numbers of components. A first embodiment is described having 3 input control circuits, 12 output circuits, and a pin jumper array for programming the input/output connections, and a second embodiment is described having 4 input control circuits, 16 output circuits, and a CPU with LCD display for programming the input/output connections. However, it should be understood that the invention is not limited in the type and number of switched circuits or input control circuits, or manner of implementing a field-programmable unit for establishing the input/out connections.

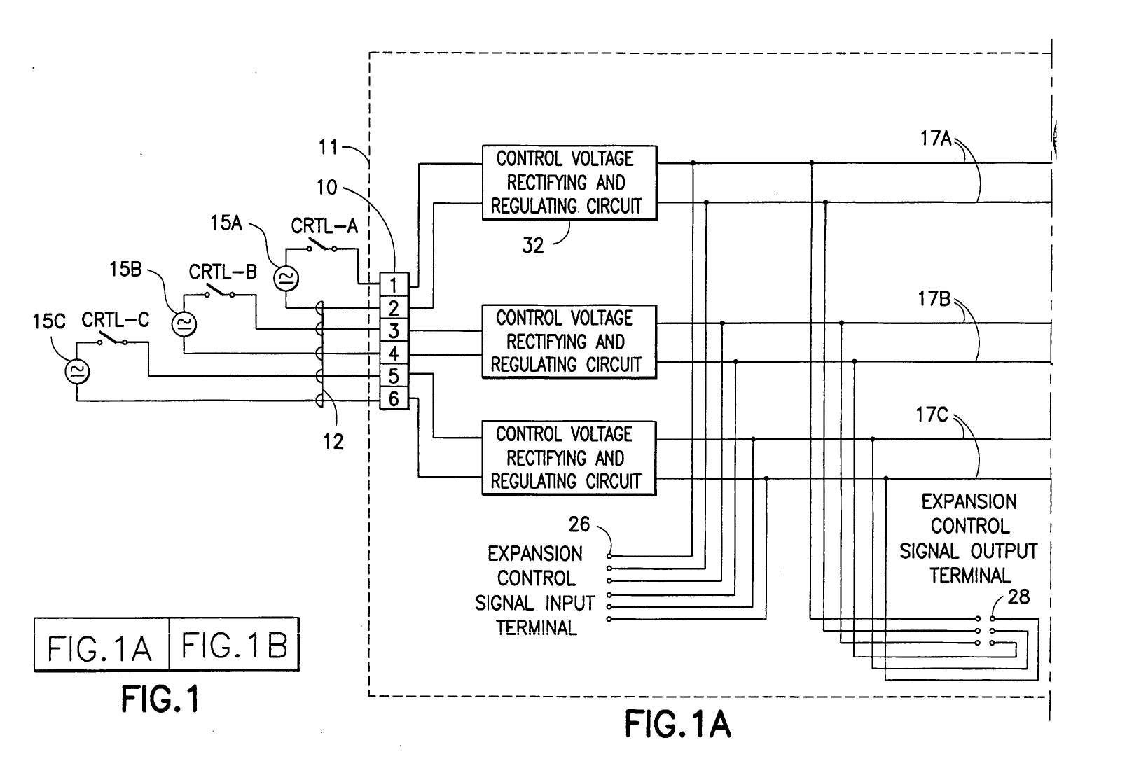

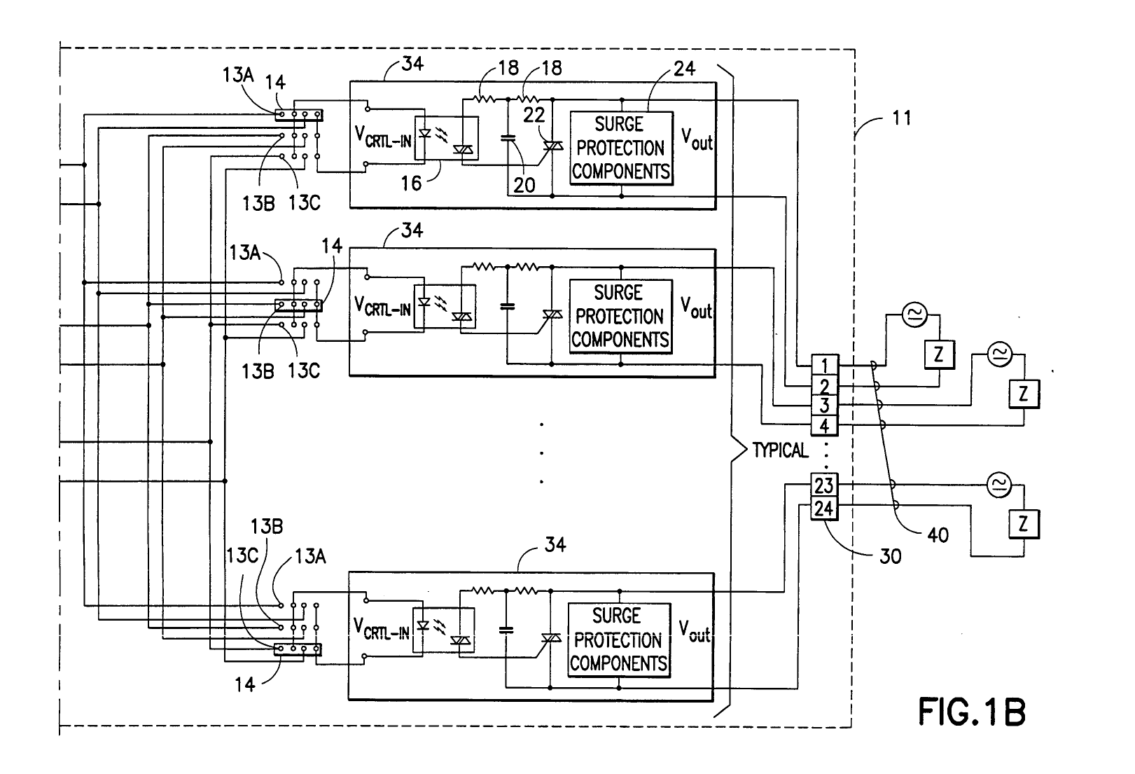

In FIG. 1A, an overall circuit configuration for the first embodiment of the invention has a control signal input terminal strip 10 mounted on a main printed circuit board (PCB) 11 which is connected by connectors 12 to input control circuits CRTL-A, CRTL-B, CRTL-C that provide signal traces 15A, 15B, 15C, respectively, when their switch actuator (such as a pushbutton or rocker actuator) is closed. The input control signals are sent to control signal rectifying and regulating circuits 32 which are mounted on removable PCBs and output as signals 17A, 17B, 17C, respectively. Control signal rectifying and regulating circuits 32 may contain a full wave rectifier, control transformer, current limiting resistors and filter capacitors to create the regulated input control signals 17A, 17B, 17C. The main printed circuit board 11 is constructed with male terminals that plug into female printed terminals of the removable PCBs. Expansion control signal input terminals 26 and output terminals 28 are provided in the event it is desired to add another main PCB in parallel for expansion.

In FIG. 1B, the regulated control signals 17A, 17B, 17C are sent on branch wiring lines to a series of selector pins for each of the array of switch units 34 carried on the main PCB. In this case, since there are 3 input control signals, there are 3 selector pins 13A, 13B, 13C that can connect any input control signal 17A, 17B, 17C to each switch unit 34. A connection is established between any of the pins 13A, 13B, 13C with a pin jumper 14 to the input terminals of the switch unit 34. Each switch unit 34 is mounted on a plug-in PCB and consists of a Triac switching circuit that is controlled by the input control signal provided. Triac switching circuits are well known in the industry, and are not described further herein. In this example, up to 12 switch units on plug-in PCBs can be mounted on the main PCB 11. Output lines from the 12 switch unit positions are sent to output terminal strip 30 (12 poles, 24 terminal pins) which can be connected by connectors 40 to respective circuits supplying power to loads Z.

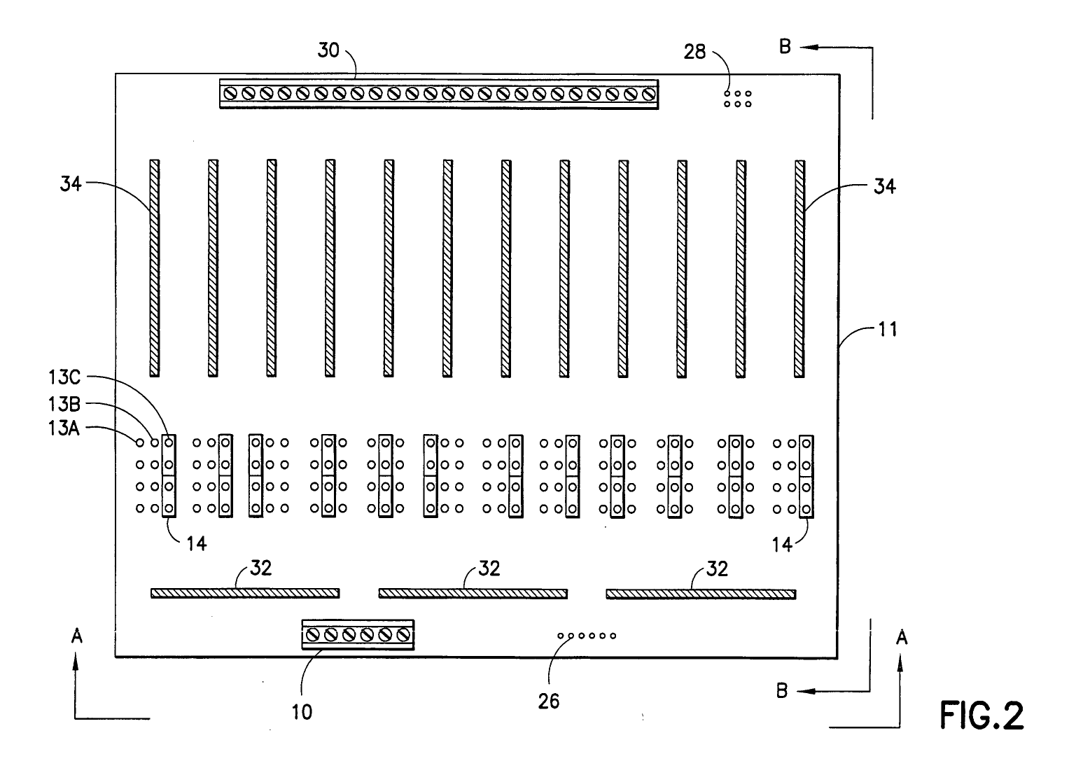

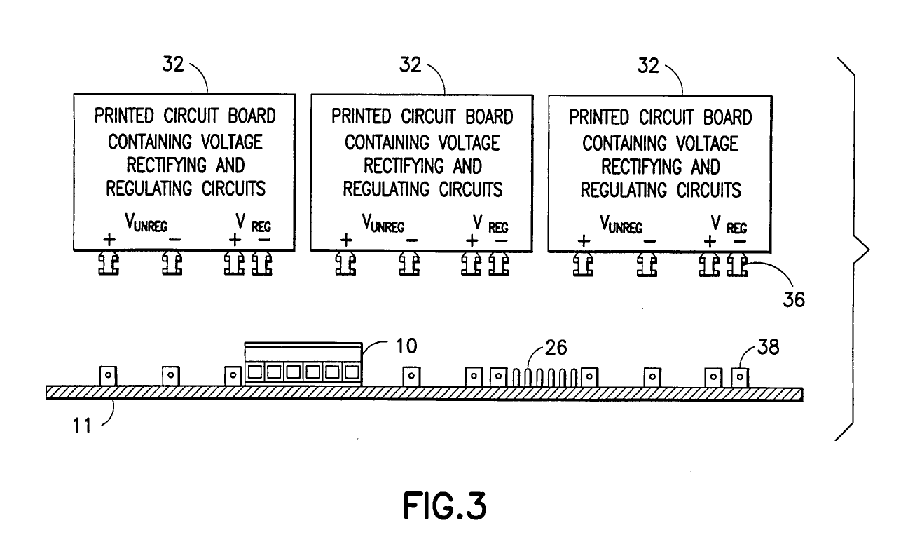

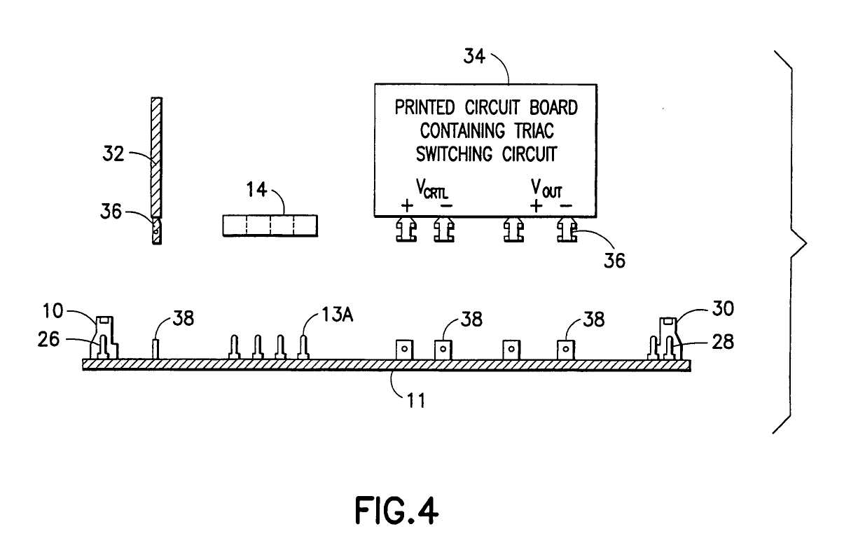

In FIGS. 2, 3, and 4, the layout of the main printed circuit board 11 of the first embodiment is shown, without the other components installed, having the input terminal strip 10, expansion connectors 26 and 28, sockets for the plug-in control signal rectifying and regulating circuits 32, pin arrays 13A, 13B, 13C and selected jumpers 14, sockets for the plug-in Triac switch units 34, output terminal strip 30. Installation and setup of the solid state multi-pole switching device by an installer in the field or a user for onsite operation is quite simple. The installer connects the input lead wires 12 from the desired input control switches to the control signal input terminal strip 10. The switched output circuit lead wires 40 are connected to the output terminal strip 30. A plug-in PCB with Triac switching circuit 34 is installed on the main PCB 11 for each switched output circuit 40 connected to the switching device. A pin jumper 14 is placed on the appropriate selector pins 13A, 13B or 13C of each switching circuit 34, depending on which input control switch CRTL-A, CRTL-B, CRTL-C is selected to control which switched output circuit. In the event additional PCBs 11 are needed to accommodate a larger number of switched output circuits 40, expansion control signal input terminals 26 and output terminals 28 are provided. The user simply connects a ribbon cable jumper between the two PCBs 11 to provide the regulated control signals 17A, 17B, 17C to the added PCB without any further field wiring.

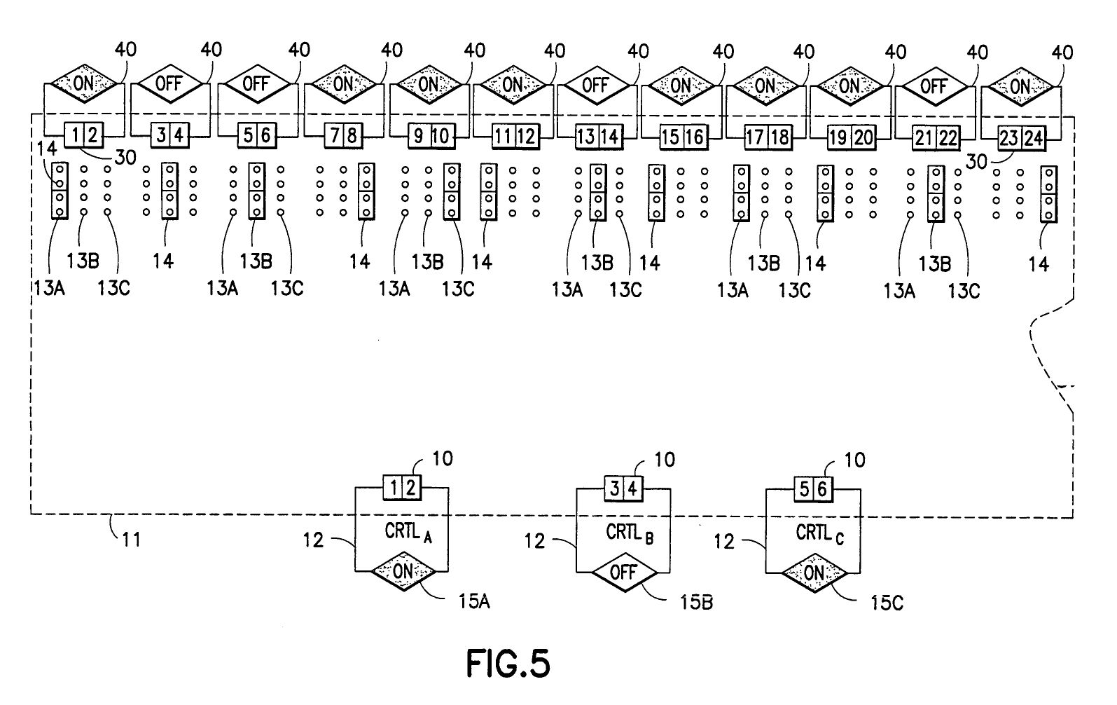

The end result is that, when the user switches on any of the control switches CRTL-A, CRTL-B, CRTL-C, the jumper-connected switched output circuits 40 will also switch on (and vice-versa for off). For example, in FIG. 5, when control signal 15A is on, all switched output circuits 40 that have selector pins 13A jumped will be on. Similarly, when control signal 15C is on, all switched output circuits 40 that have selector pins 13C jumped will be on. Since the control signal 15B is off, the switched output circuits 40 that have selector pins 13C jumped remain off.

In the event more switched circuits need to be added after field installation, additional plug-in PCBs containing a Triac switching circuit 34 can be plugged into the main PCB 11. Similarly, if additional control signal lines become necessary, additional plug-in PCBs 32 containing control signal rectifying and regulating circuits can be plugged into the main PCB 11.

Other types of components, methods of construction, and features may be substituted or used given the principles of operation of the switching device. Different numbers (“n”) of input control circuits and (“m”) of switch units and switched output circuits may be used. Other types of semiconductor switching circuits, opto-isolators, switch control devices that operate with AC or DC input, transistor type output circuits, random crossing and zero crossing Triac output circuits, various thyristor circuits including silicon controlled rectifiers (SCRs), silicon controlled switches (SCS), 4-layer diodes, and Diacs may be used. Other alternatives to the pin and jumper arrangement include mechanical switches, solid state switching circuits or screwed down contact jumpers, and a computer CPU-controlled embodiment is described below. Alternatives to the described main and plug-in PCBs described including reversing the male/female arrangement of the terminals, or using quick connect type terminals, screwed down contacts and supports, twist lock connectors, headers, pins, sockets and receptacles, terminal blocks and wire. An alternative to the modular component design is to put all the device components on a single printed circuit board. Other features that can be added to the device include a front panel display indicating device conditions, pilot lights, LEDs, LCD display, LCD or TFT screen, auxiliary contacts for each controlled circuit, circuit board rearrangement for space saving or cost effectiveness, internal control power source, timer circuits for automatic operation without external control signals, local circuit control, override switches, etc.

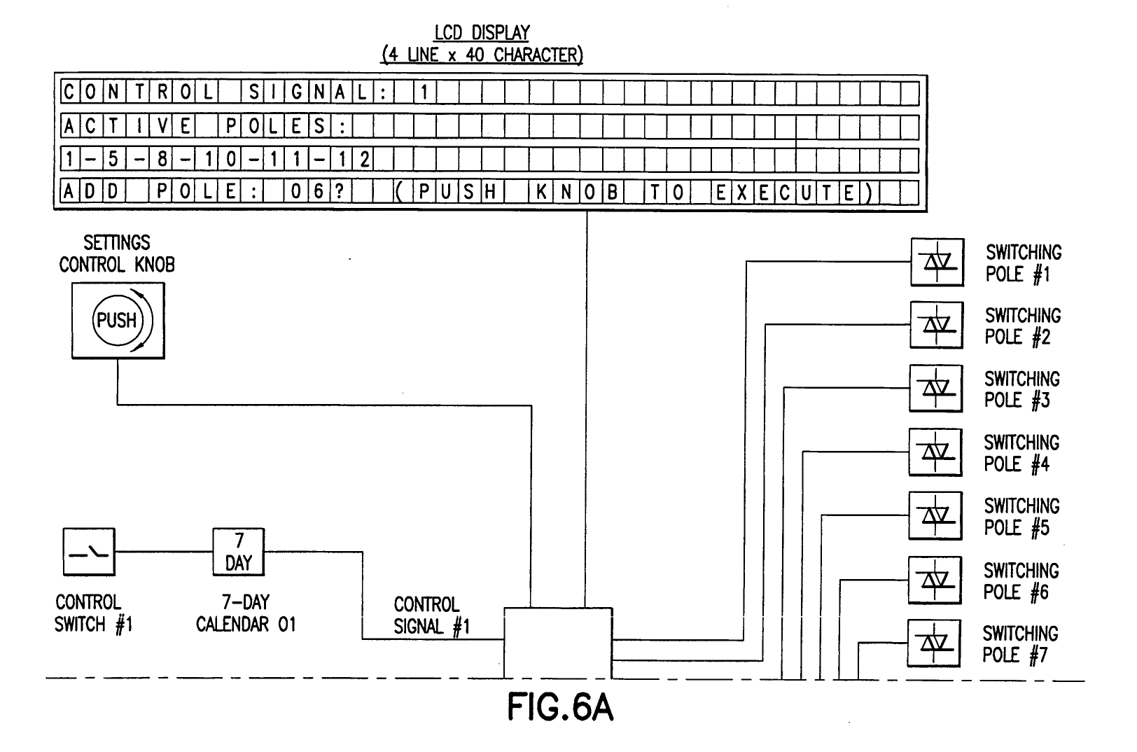

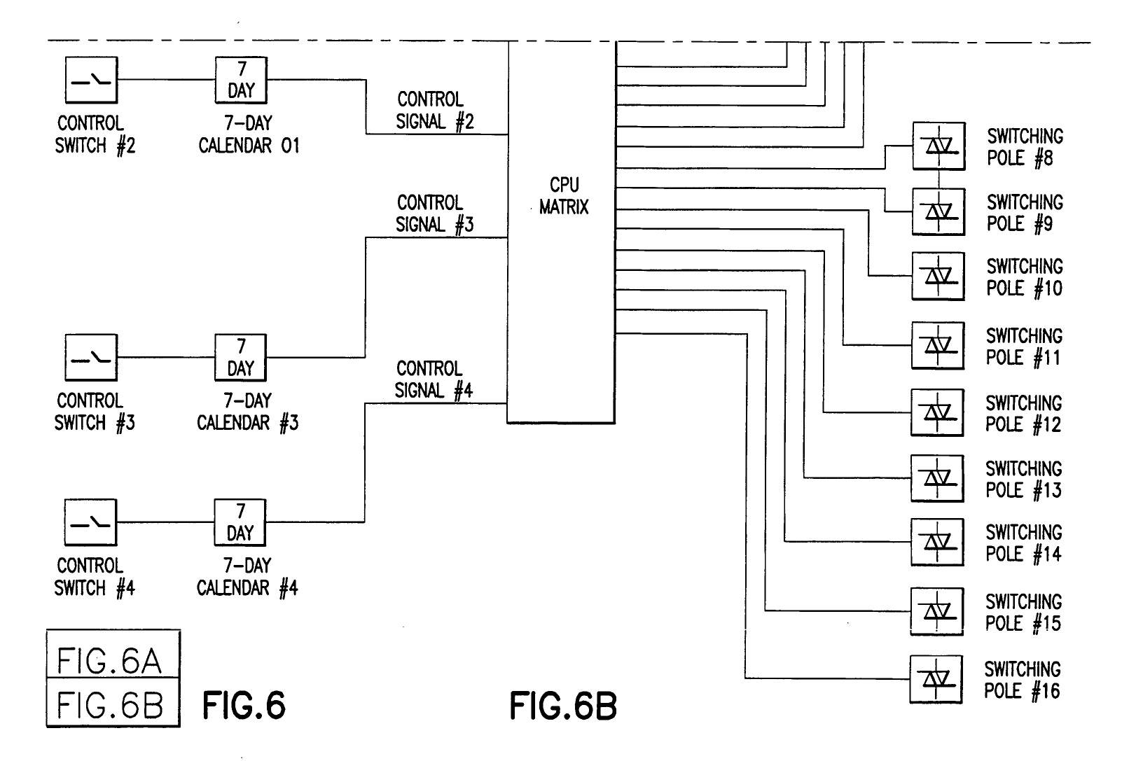

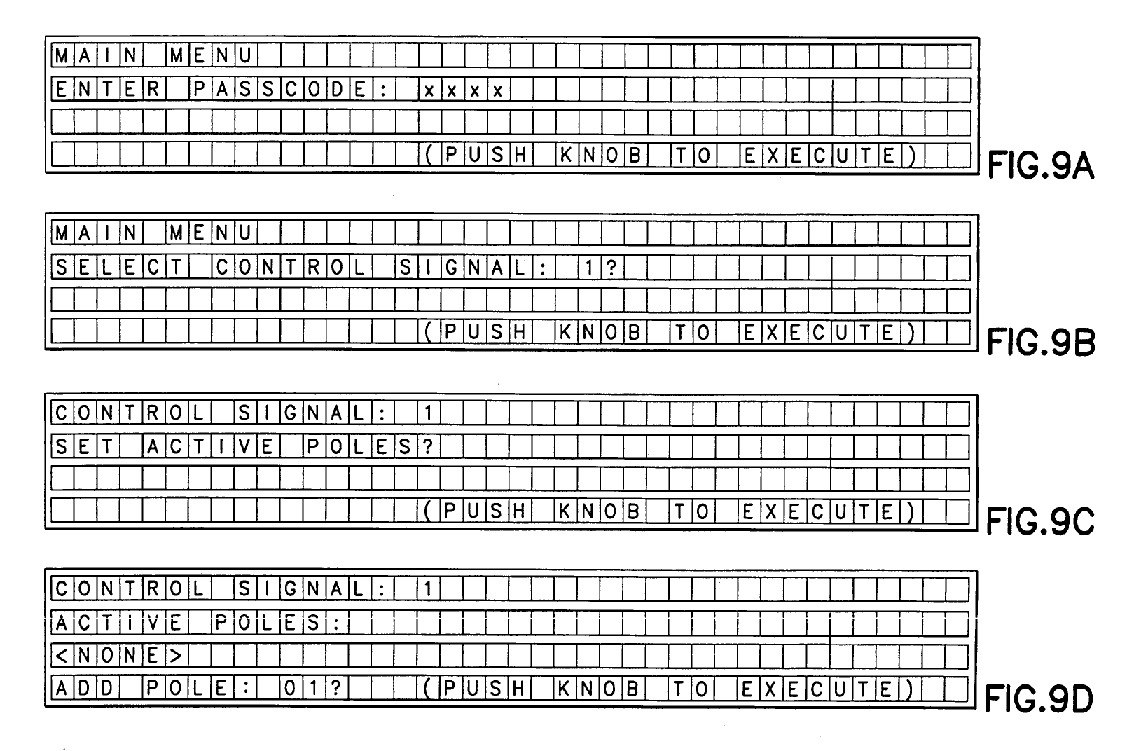

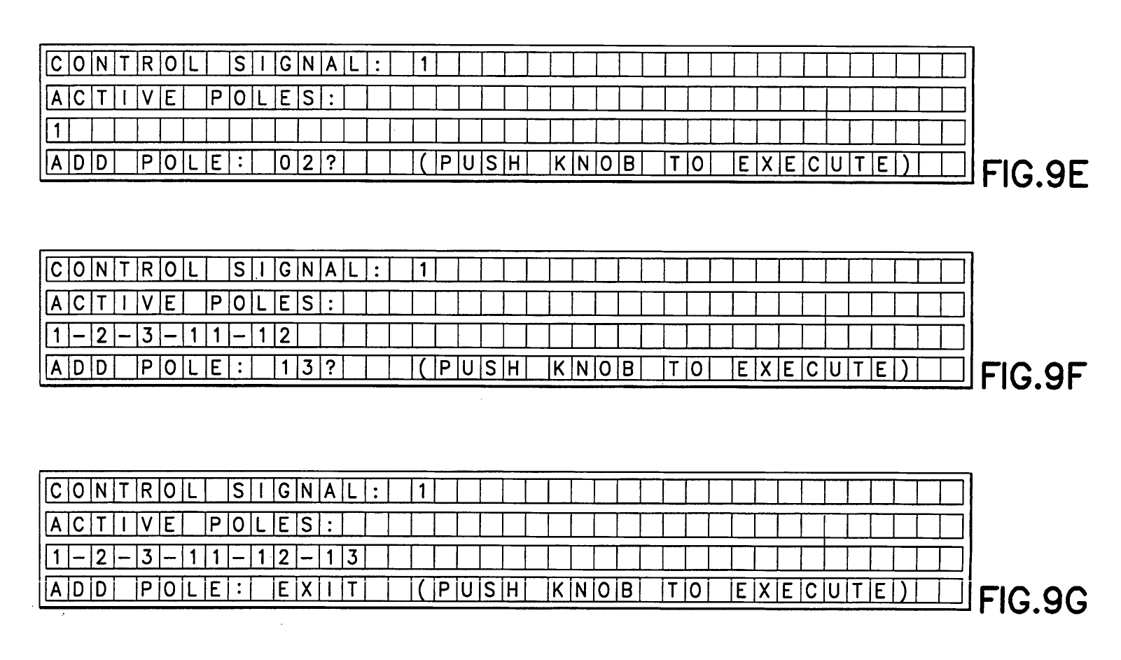

In FIG. 6, an alternative embodiment of the present invention employs a CPU field-programmable unit in place of the mechanically set pin-and-jumper arrangement. In this example, input control switches #1-#4 (max n=4) are provided to control any of switching circuits #1-#16 (max m=16). Input lines from the input control switches and output lines to the switching circuits are connected to the pin terminals of the CPU, and the CPU is installed with a program that allows setting of the input/output connections in an electronic equivalent of the pin-and-jumper arrangement (described below with reference to FIGS. 9-11). The CPU is coupled to an LCD display and settings control knob (turn to scroll, push to set) for setting the input/output connections in the field or for onsite operation. As a further feature, the CPU may be programmed to provide 7-day timer controls #1-#4 for automatic on/off switching operation of the output circuits without the need to manually activate external control signals.

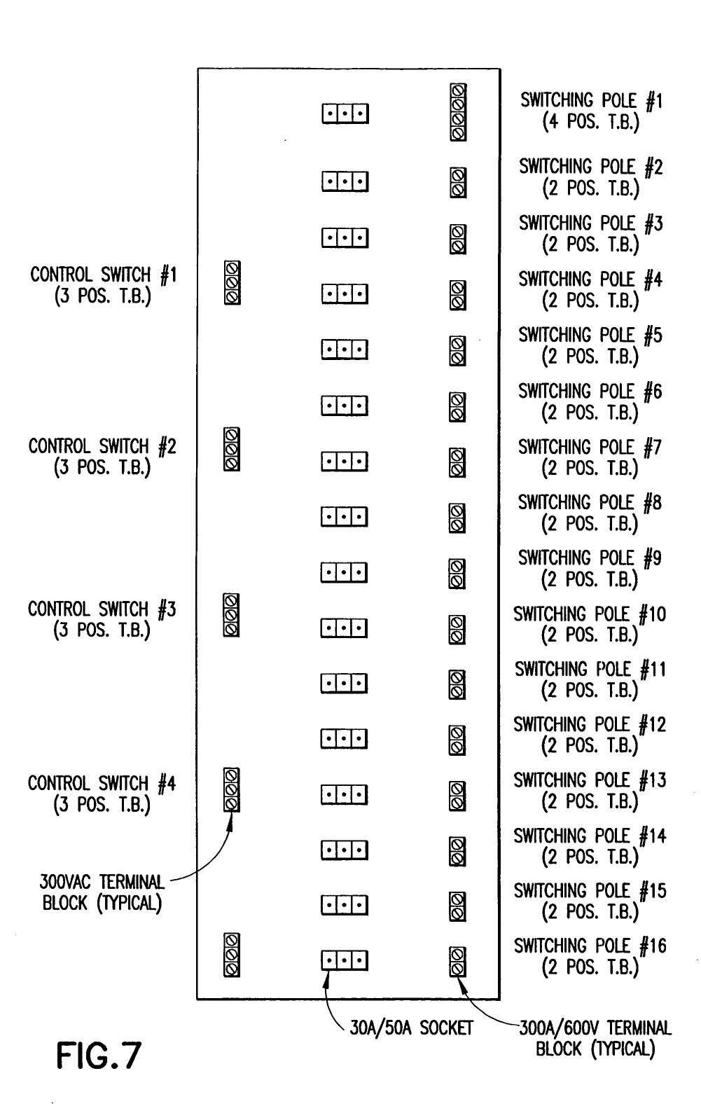

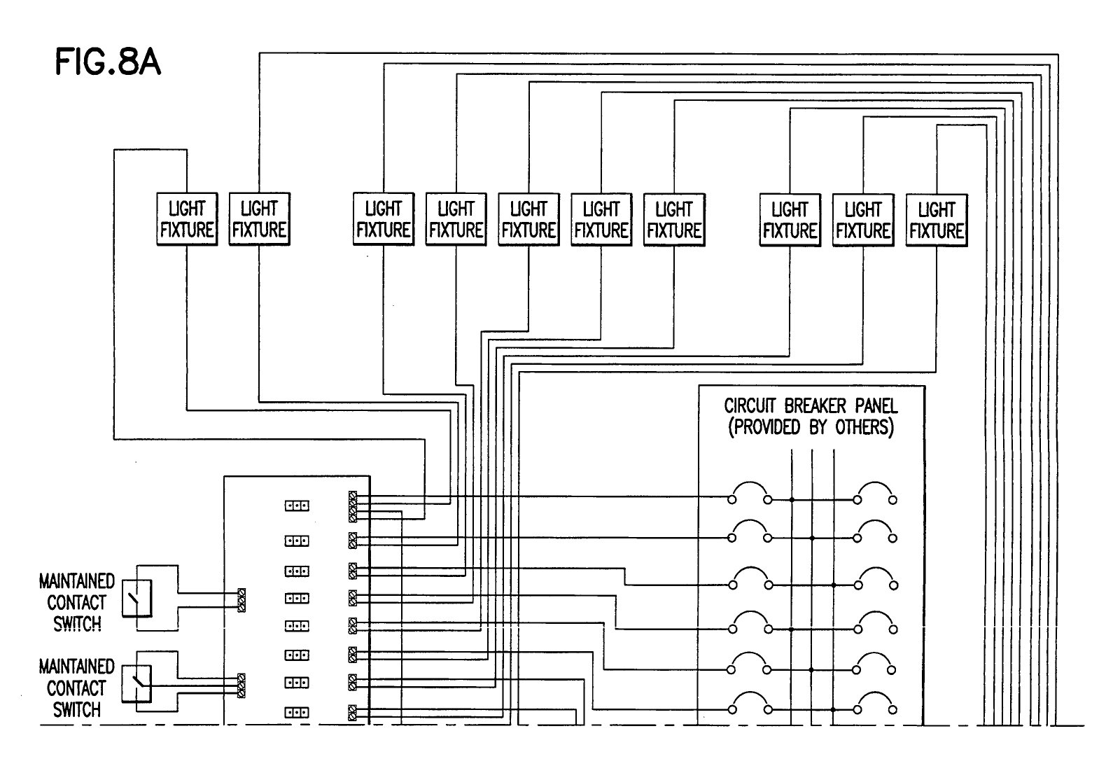

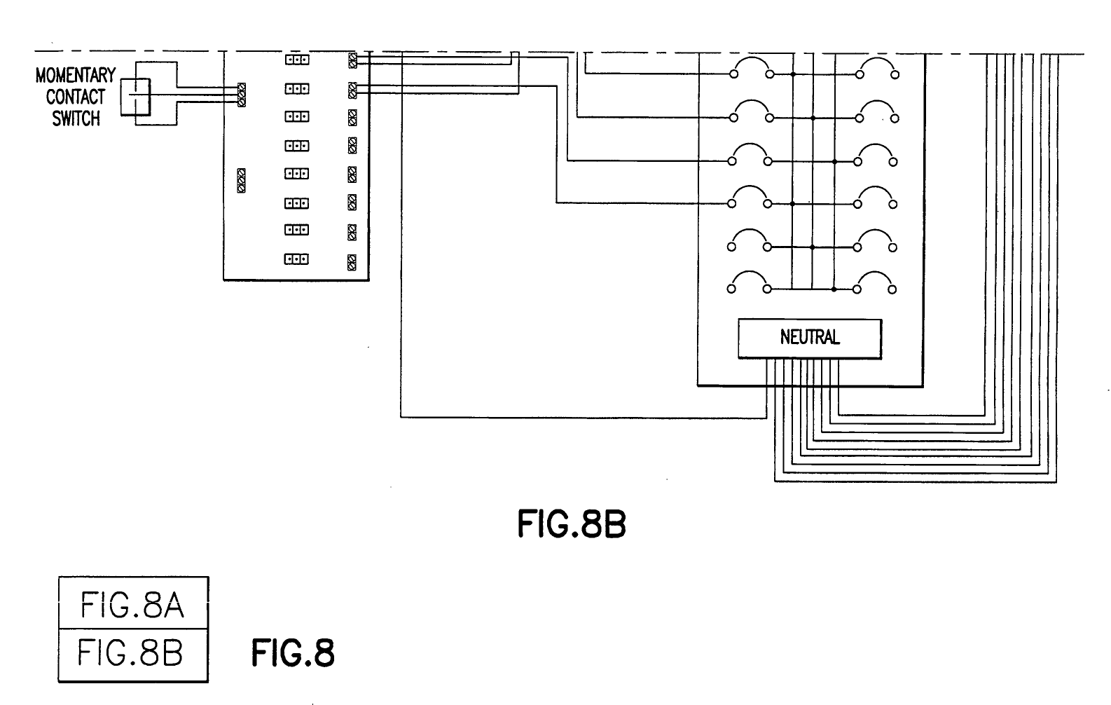

In FIG. 7, a circuit board layout (without components) for the CPU-controlled embodiment includes input terminals for control switches #1-#4, 16 socket positions for plug-in PCBs for the Triac switching circuits, and output terminals for output circuits (switching poles) #1-#16. In FIG. 8, a typical installation wiring scenario is shown in which 3 input control switches are installed, and 10 output circuits are connected to respective light fixtures and to circuit breakers on the ground (neutral) side.

FIGS. 9A-9G illustrate the programming of the CPU-controlled input/output connections by an installer in the field or user for onsite operation using the attached 4-line LCD display and setting control knob. In FIG. 9A, a main menu display is shown prompting the user to enter a passcode. Each digit of the passcode can be set in sequence by turning the knob to bring the number up/down then pushing the knob to set that digit. When all passcode digits have been set, the knob is pushed to execute entry into the setting program. In FIG. 9B, the main menu of the setting program prompts the user to select which input control signal is to be set. The control signal number can be set by turning the knob to bring the number up/down then pushing the knob to set, then the knob is pushed to execute. In FIG. 9C, the user is prompted to enter the programming for connecting the selected control signal with the desired output circuits (“active poles”).

In FIG. 9D, the user is prompted to enter an active pole number to be connected. The active pole number can be set by turning the knob to bring the number up/down then pushing the knob to set, then the knob is pushed to execute. In FIG. 9E, the user is prompted to enter another pole number to be connected. In FIG. 9F, the poles that have been set are displayed on the 3^{rd} line of the display. In FIG. 9G, the user can exit the setting program by turning the knob until “Exit” appears in the pole number field, then pushing the knob to exit.

The CPU is set to display the maximum number of input control switches and active poles that the main PCB is designed for. The control signal settings can be changed by the user at any time. Not all switching poles need to be connected at the time of initial onsite installation. Additional switching poles can be added later and programmed to the desired control signal(s) onsite. The setting program may be operated in a mode where only one control signal can control a pole, so if the pole has been previously assigned to another control signal, it will be removed from the old control signal and be assigned to the currently designed control signal. Alternatively, the program may operate in a mode where more than one control signal can switch a pole, in which case setting a current control signal would not erase a previous setting for another control signal.

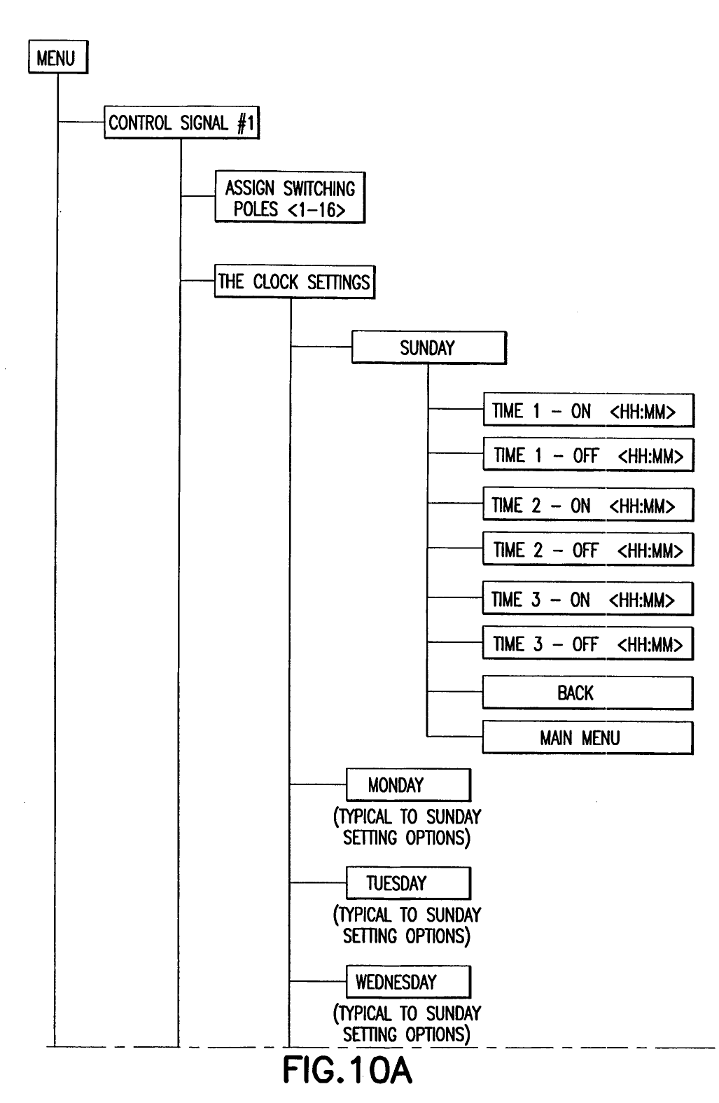

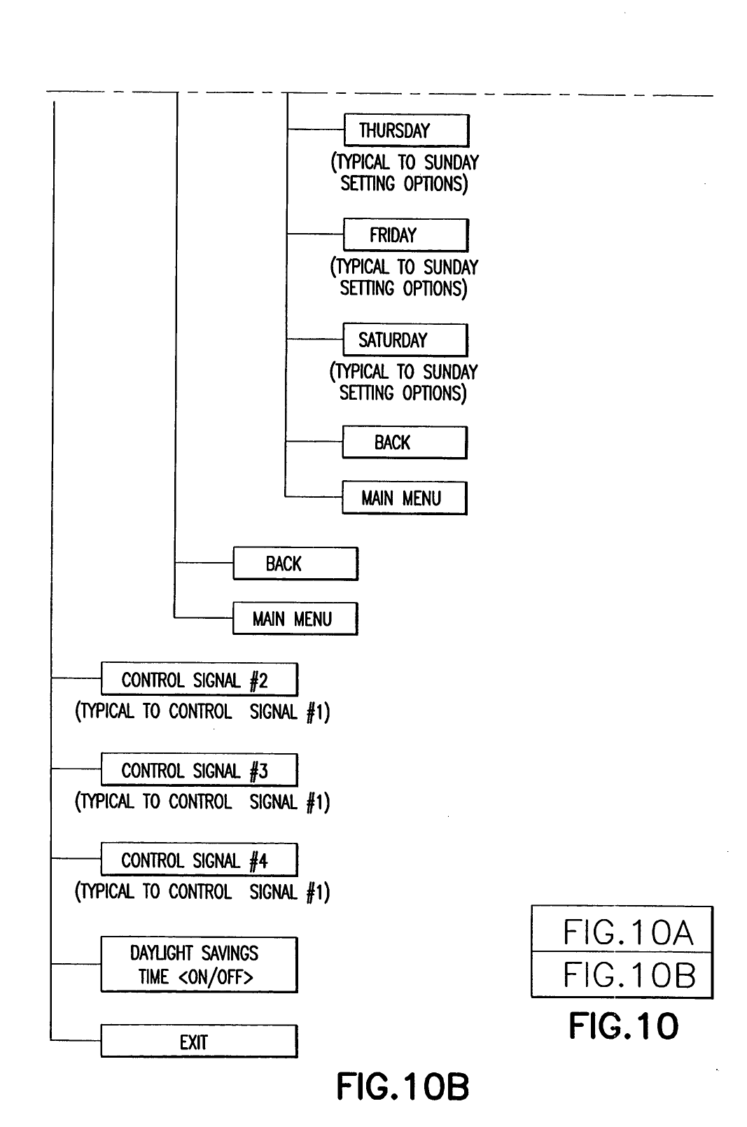

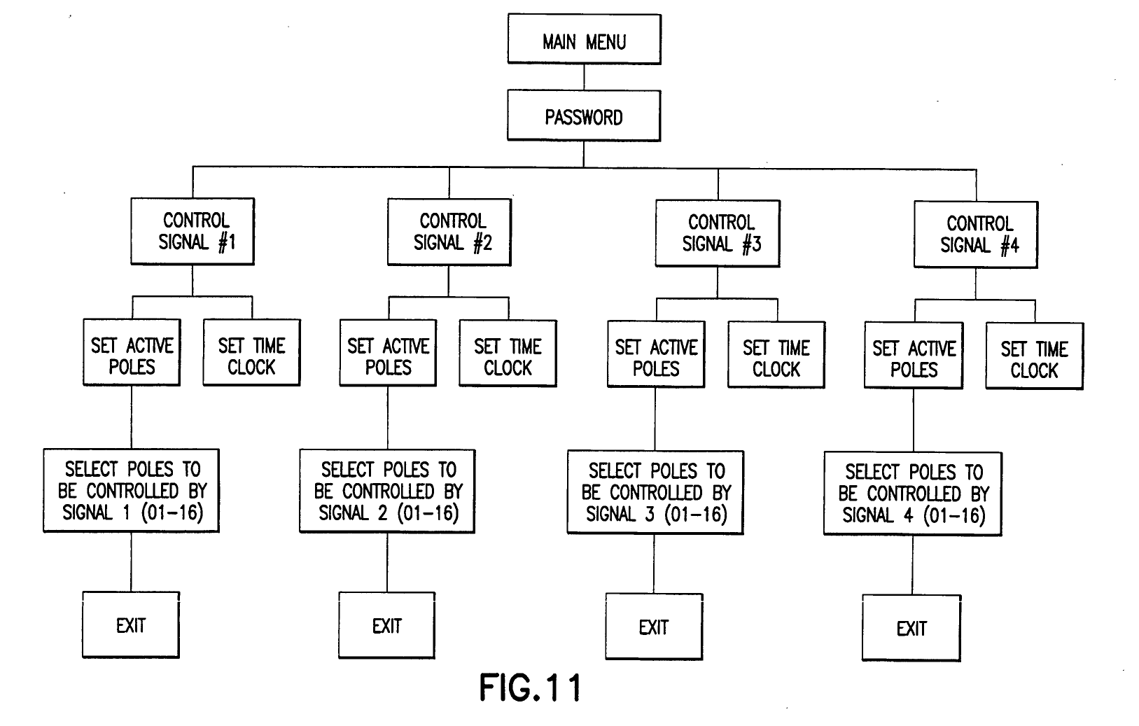

In FIG. 10, a control signal setup menu for the CPU is shown which includes programming of 7-day calendar controls for automatic on/off switching operation of the switching poles without the need to manually activate external control signals. The menu allows the user to step through the programming of each control signal by assigning the switching poles (as described above), then setting the 7-day calendar by stepping through the days of the week and setting the hours/minutes time periods of on/off operation. In FIG. 11, a logic diagram for the programming the CPU is shown in which the setting program steps through from the main menu and passcode entry to setting any of the control signals #1-#4 by setting the active poles to be connected to the control signal and the 7-day time clock on/off periods.

Preferably, the main board contains all control signal regulating circuits, input/output terminal blocks, and sockets for the plug-in switching circuit boards. Power supply for switched loads is obtained from any one of the switching circuits. Upon failure of any circuit, the switching device can continue to operate if there is power supplied to the other circuits. The first switching circuit #1 is shown with a 4-position terminal block, as 2 positions are used for the control power neutral (ground reference point). The device may be configured to accept outside control power signals instead of onboard control power. The 7-day calendars may be initialized to automatically adjust for daylight savings and leap years. The output circuits can be grouped and controlled by input control signals in any desired combination. The modular design with plug-in components enabled additional units to be installed at any time and programmed as desired.

It is understood that many modifications and variations may b e devised given the above description of the principles of the invention. It is intended that all such modifications and variations be considered as within the spirit and scope of this invention, as defined in the following claims.

1. A solid state multi-pole switching device comprising:
(a) a first plurality (n) of input control circuits each configured to provide an individual input control signal for controlling the switching of one or more output circuits;
(b) a second plurality (m) of output circuits each having an associated solid-state switch unit connected to an output terminal (pole) connectable to a respective external circuit load;
(c) a field-programmable unit coupled between the n input control circuits and the m output circuits for selectively establishing an electrical connection connecting any input control signal to one or more solid-state switch units for any selected one or more of the output circuits,
whereby the n input control circuits can be connected by the field-programmable unit to any of the m solid state switch units for the output circuits in any desired combination of groupings controlled by any selected ones of the input control signals.

2. A solid state multi-pole switching device according to claim 1, wherein input terminals for the input control circuits, solid-state switch units, and output terminals (poles) for the output circuits are all carried on a main circuit board.

3. A solid state multi-pole switching device according to claim 2, wherein said main circuit board has an array of sockets for selectively installing the switch units mounted on plug-in circuit boards therein.

4. A solid state multi-pole switching device according to claim 1, wherein said field-programmable unit is provided by n pin-jumper positions for each of the m output circuits, and desired connections are established by installing jumpers connecting each selected input control circuit to each selected output circuit.

5. A solid state multi-pole switching device according to claim 1, wherein said field-programmable unit is provided by a CPU coupled to a display and a settings control device for establishing desired electronic connections from each selected input control circuit to each selected output circuit.

6. A solid state multi-pole switching device according to claim 5, wherein said CPU has a settings program which provides a menu to enable the user to set desired connections to the selected output circuits for any of the input control circuits.

7. A solid state multi-pole switching device according to claim 5, wherein said settings control device is a settings control knob that is turned to scroll up/down through numbers and/or menu options and pushed to set or execute a number or option.

8. A solid state multi-pole switching device according to claim 5, wherein said CPU includes a timer control program for setting 7-day calendar controls for each input control circuit for automatic on/off switching operation of the selected output circuits without the need to manually activate external input control signals.

9. A solid state mult-pole switching device according to claim 6, wherein said settings program operates in a mode where said input control signal of only one of said input control circuits controls said output terminal (pole) of one of said output circuits.

10. A solid state multi-pole switching device according to claim 6, wherein said settings program operates in a mode where said input control signal of more than one of said input control circuits controls said output terminal (pole) of one of said output circuits.

11. A solid state multi-pole switching device according to claim 2, wherein said main circuit board includes timer controls for setting 7-day calendar controls for each input control circuit for automatic on/off switching operation of the selected output circuits without the need to manually activate external input control signals.

12. A solid state multi-pole switching device according to claim 1, adapted for field installation or onsite operation of multi-circuit switching control.

13. A solid state multi-pole switching device comprising:
(a) a main circuit board having input terminals for a first plurality (n) of input control circuits, each configured to provide an individual input control signal for controlling the switching of one or more output circuits, and output terminals for a second plurality (m) of output circuits, each having an associated solid-state switch unit connected to a respective output terminal (pole) connectable to a respective external circuit load; and
(b) a field-programmable unit coupled between the input terminals for the n input control circuits and the output terminals for the m output circuits for selectively establishing an electrical connection connecting any input control signal to one or more solid-state switch units for any selected one or more of the output circuits.

14. A solid state multi-pole switching device according to claim 13, wherein said main circuit board has an array of sockets for selectively installing the switch units mounted on plug-in circuit boards therein.

15. A solid state multi-pole switching device according to claim 13, wherein said field-programmable unit is provided by n pin-jumper positions for each of the m output circuits, and desired connections are established by installing jumpers connecting each selected input control circuit to each selected output circuit.

16. A solid state multi-pole switching device according to claim 13, wherein said field-programmable unit is provided by a CPU coupled to a display and a settings control device for establishing desired electronic connections from each selected input control circuit to each selected output circuit.

17. A solid state multi-pole switching device according to claim 16, wherein said CPU has a settings program which provides a menu to enable the user to set desired connections to the selected output circuits for any of the input control circuits.

18. A solid state multi-pole switching device according to claim 16, wherein said settings control device is a settings control knob that is turned to scroll up/down through numbers and/or menu options and pushed to set or execute a number or option.

19. A solid state multi-pole switching device according to claim 16, wherein said CPU includes a timer control program for setting 7-day calendar controls for each input control circuit for automatic on/off switching operation of the selected output circuits without the need to manually activate external input control signals.

20. A solid state mult-pole switching device according to claim 17, wherein said settings program operates in a mode where said input control signal of only one of said input control circuits controls said output terminal (pole) of one of said output circuits.

21. A solid state multi-pole switching device according to claim 17, wherein said settings program operates in a mode where said input control signal of more than one of said input control circuits controls said output terminal (pole) of one of said output circuits.

22. A solid state multi-pole switching device according to claim 13, wherein said main circuit board includes timer controls for setting 7-day calendar controls for each input control circuit for automatic on/off switching operation of the selected output circuits without the need to manually activate external input control signals.

23. A solid state multi-pole switching device according to claim 13, wherein said main circuit board includes an on-board power supply control for supplying power to loads on the switched output circuits.

24. A solid state multi-pole switching device according to claim 13, adapted for multi-circuit switching control applications.
